(19) United States
(12) Patent Application Publication
(10) Pub. No.: US 2022/0188738 A1
(43) Pub. Date: Jun. 16, 2022

(54) ENTERPRISE NETWORK STATUS INSIGHT SYSTEM AND METHOD

(71) Applicant: Hartford Fire Insurance Company, Hartford, CT (US)

(72) Inventors: Patrick D. Brown, Marlboro, CT (US); Ricky Coughlin, Hartford, CT (US); Melissa Standish Dudzic, Colchester, CT (US); Michael D Horrigan, Avon, CT (US); Corrine Johnson, Santee, CA (US); Michael T. Reagan, Riverview, FL (US); Hank A Tokarz, Goodyear, AZ (US); Lisa Marie Tolleson, Blanchard, OK (US); Elizabeth A Sprague, Ellington (US); Vladimir Sarnavsky, Avon, CT (US); Judith A. Philbin, Vernon, CT (US); Paul Adomeit, Hartford, CT (US); MIchele M Gagnon, Manchester, CT (US)

(21) Appl. No.: 17/123,867

(22) Filed: Dec. 16, 2020

(51) Int. Cl. G06Q 10/06; G06Q 40/08; G06N 20/00; H04L 12/26

(52) U.S. Cl. CPC G06Q 10/063114; G06Q 10/06312; H04L 43/0805; G06N 20/00; G06Q 40/08

(57) ABSTRACT

Embodiments may be associated with a network status insight system implemented via a back-end application computer server. A network provider data store may contain electronic records, each electronic record representing a network provider of an enterprise. An enterprise data store may contain electronic records, each electronic record representing a remote analysis entity of the enterprise (e.g., a remote employee or worker). The computer server may receive, from the enterprise data store, information about analysis entities of the enterprise and, from the network provider data store, information about networks used by the enterprise. The computer may also receive, from a third-party outage detector platform information about outages associated with the enterprise (e.g., network outages and/or power outages). A network status algorithm may then be applied to correlate the received information to generate enterprise network status results (e.g., for display on an insight dashboard and/or a risk assessment prediction for the enterprise).

### TECHNICAL FIELD

The present application generally relates to computer systems and more particularly to computer systems that are adapted to accurately and/or automatically provide network status insight information for an enterprise.

### BACKGROUND

An enterprise, such as a business corporation, may utilize remote employees (e.g., employees who “work from home) that access centralized servers or cloud services via networks. There are various potential problems associated with such access that can pose substantial risks to the enterprise. For example, Internet Service Provider (“ISP”) network outages, electric power outages (e.g., associated with local weather events), problems with an employee's local router (e.g., resulting from other members of the household streaming data), etc. can all disrupt an employee's ability to work remotely. These risks can be substantial, especially when a large number of employees are working remotely (e.g., during a widespread health crisis).

It can be difficult to manually and accurately predict a level of risk for a particular enterprise. Similarly, it can be difficult to analyze and respond to problems in substantially real time—especially when there are a substantial number of remote employees. For example, the greatest new risk for remote worker enablement during a pandemic response may be the ability of the enterprise to successfully and consistently connect to systems to perform needed business functions. Primary among these concerns may be the ability of local ISPs to maintain a level of service to enable remote work.

It would be desirable to provide systems and methods to accurately and/or automatically provide network status insight information in a way that provides fast and accurate results. Moreover, the network insight information should be easy to access, understand, interpret, update, etc.

### SUMMARY OF THE INVENTION

According to some embodiments, systems, methods, apparatus, computer program code and means are provided to accurately and/or automatically provide network status insight information in a way that provides fast and accurate results and that allow for flexibility and effectiveness when responding to those results.

Embodiments may be associated with a network status insight system implemented via a back-end application computer server. A network provider data store may contain electronic records, each electronic record representing a network provider of an enterprise. An enterprise data store may contain electronic records, each electronic record representing a remote analysis entity of the enterprise (e.g., an employee or worker). The computer server may receive, from the enterprise data store, information about analysis entities of the enterprise and, from the network provider data store, information about networks used by the enterprise. The computer may also receive, from a third-party outage detector platform information about outages associated with the enterprise (e.g., network outages and/or power outages). A network status algorithm may then be applied to correlate the received information to generate enterprise network status results (e.g., for display on an insight dashboard and/or a risk assessment prediction for the enterprise).

Some embodiments comprise: means for receiving, at a computer processor of a back-end application computer server from an enterprise data store, information about analysis entities of the enterprise, wherein the enterprise data store contains electronic records, each electronic record representing a remote analysis entity of the enterprise and including, for each analysis entity, an electronic record identifier and a set of analysis entity attribute values; means for receiving, from a network provider data store, information about networks used by the enterprise, wherein the network provider data store contains electronic records, each electronic record representing a network provider of an enterprise and including, for each network provider, an electronic record identifier and a set of network attribute values; means for receiving, from a third-party outage detector platform, information about outages associated with the enterprise; means for applying a network status algorithm to correlate the information about analysis entities of the enterprise, the information about networks used by the enterprise, and the information about outages associated with the enterprise to generate enterprise network status results; and means for arranging to output an indication of the enterprise network status results through a communication port and interactive user interface displays, including the enterprise network status results, via a distributed communication network.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to accurately and/or automatically provide network status insight information in a way that provides fast and accurate results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a network status insight system in accordance with some embodiments.

FIG. 2 illustrates a network status insight method according to some embodiments of the present invention.

FIG. 3 is a network status insight display according to some embodiments.

FIG. 4 is a dashboard maturity process in accordance with some embodiments.

FIG. 5 is a remote worker connectivity dashboard architecture according to some embodiments.

FIG. 6 illustrates use case examples and roadmap items in accordance with some embodiments.

FIG. 7 is a multi-day connectivity drop trend display according to some embodiments.

FIG. 8 shows a display with other types of VPN connectivity drops in accordance with some embodiments.

FIG. 9 is an offshore vendor display according to some embodiments.

FIG. 10 is a power outage analytic solution display in accordance with some embodiments.

FIG. 11 is an affected employee power outage display according to some embodiments.

FIG. 12 is a multi-lay map of power outages display in accordance with some embodiments.

FIG. 13 is a heat map display according to some embodiments.

FIG. 14 is a contact center management use case display in accordance with some embodiments.

FIG. 15 is a drop trend display according to some embodiments.

FIG. 16 illustrates a tablet computer with a street-level router drop display according to some embodiments.

FIG. 17 illustrates a non-employee analysis entity display according to some embodiments.

FIG. 18 is a block diagram of an apparatus in accordance with some embodiments of the present invention.

FIG. 19 is a portion of a tabular historical network status database according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only, and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data analytics associated with network insight information. The present invention is directed to more than merely a computer implementation of a routine or conventional activity previously known in the industry as it provides a specific advancement in the area of electronic record analysis by providing improvements in data leveraging to identify network insight risk factors, identify the effect of these network insight risk factors on outcomes, and identify network insight risk mitigation strategies to improve outcomes. The present invention provides improvement beyond a mere generic computer implementation as it involves the novel ordered combination of system elements and processes to provide improvements in data leveraging to identify network insight risk factors. Some embodiments of the present invention are directed to a system adapted to automatically analyze network status records, aggregate data from multiple sources, automatically identify network insight risk drivers, automatically identify how these network insight risk drivers might affect insurance claim outcomes, and/or automatically provide network insight risk mitigation strategies that improve enterprise responses. Moreover, communication links and messages may be automatically established, aggregated, formatted, etc. to improve network performance (e.g., by reducing an amount of network messaging required to correct an existing problem).

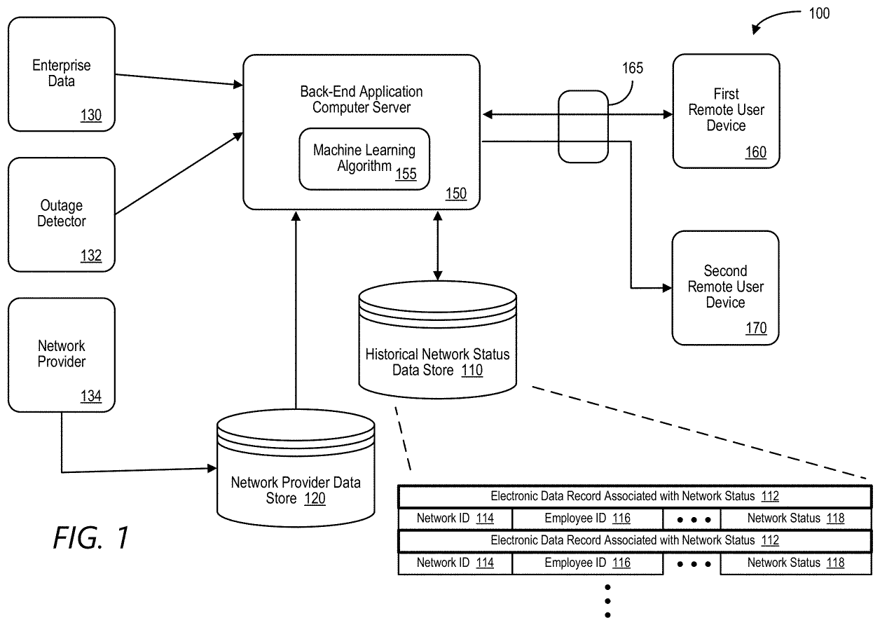

FIG. 1 is a high-level block diagram of a network status insight system 100 according to some embodiments of the present invention. In particular, the system 100 includes a back-end application computer 150 server that may access information in a historical network status data store 110 (e.g., storing a set of electronic records associated with network status 112, each record including, for example, one or more network identifiers 114, employee identifiers 116 or identifiers associated with other types of analysis entities, network status 188, etc.). The back-end application computer server 150 may also retrieve information from other data stores or sources, such as a network provider data store 120 and utilize a Machine Learning (“ML”) or Artificial Intelligence (“AI”) algorithm 155 to view, analyze, and/or update the electronic records. The back-end application computer server 150 may also exchange information with a first remote user device 160 and a second remote user device 170 (e.g., via a firewall 165). According to some embodiments, an interactive graphical user interface platform of the back-end application computer server 150 (and, in some cases, third-party data) may facilitate forecasts, decisions, predictions, and/or the display of results via one or more remote administrator computers (e.g., to gather additional information about a network) and/or the remote user devices 160, 170. For example, the first remote user device 160 may transmit annotated and/or updated information to the back-end application computer server 150. Based on the updated information, the back-end application computer server 150 may adjust data in the historical network status data store 110 and/or the network provider data store 120 and the change may be viewable via the second remote user device 170. Note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records in the historical network status data store 110. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the historical network status data store 110 and/or the network provider data store 120. The data stores 110, 120 may be locally stored or reside remote from the back-end application computer server 150. As will be described further below, the historical network status data store 110 may be used by the back-end application computer server 150 in connection with an interactive user interface to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and historical network status data store 110 might be co-located and/or may comprise a single apparatus.

The back-end application computer server 150 may analyze information from enterprise data 130 (e.g., a Human Resources (“HR”) department computer system), an outage detector 132 (e.g., adapted to detect network or power outages), and/or a network provider 134 (e.g., either directly or via the network provider data store 120 as illustrated in FIG. 1).

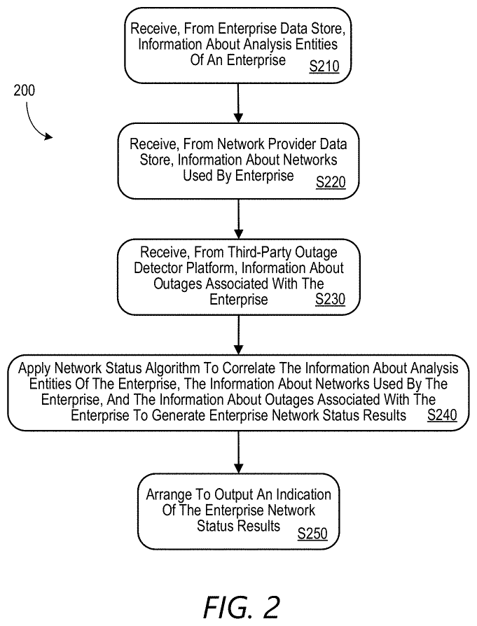

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may receive, from an enterprise data store, information about analysis entities of the enterprise. The enterprise data store may contain, for example, electronic records, each electronic record representing a remote employee of the enterprise and including, for each employee, an electronic record identifier and a set of employee attribute values. Examples of employee attribute values might include an employee identifier, an employee name, an employee status (e.g., online or offline), a network service provider, a communication address (e.g., an IP address, telephone number, etc.), location information (e.g., a latitude and longitude, a ZIP code, a home postal address), etc.

At S220, the system may receive, from a network provider data store, information about networks used by the enterprise. The network provider data store may contain, for example, electronic records, each electronic record representing a network provider of an enterprise and including, for each network provider, an electronic record identifier and a set of network attribute values. The network attribute values might include, for example, a network identifier, a network status, a network address (e.g., an IP address, a Media Access Control (“MAC”) address, etc.), location information (e.g., a latitude and longitude, a ZIP code, an ISP postal address), a status date and time, etc.

At S230, the system may receive, from a third-party outage detector platform, information about outages associated with the enterprise. As used herein, the phrase “third-party” may refer to, for example, a party independent of the system, the enterprise, and the network provider. According to some embodiments, the third-party outage detector platform comprises a network outage detector platform. According to other embodiments, the third-party outage detector platform comprises a power outage detector platform. In still other embodiments, the back-end application computer server receives information from both a network outage detector platform and a power outage detector platform.

At S240, the back-end application computer server may apply a network status algorithm to correlate (1) the information about analysis entities of the enterprise (e.g., employees or workers), (2) the information about networks used by the enterprise, and (3) the information about outages associated with the enterprise to generate enterprise network status results. Note that the back-end application computer server might also receive crowdsourced information from at least one crowdsourcing platform. For example, it might be detected that many employees in a particular area are calling or texting an enterprise IT department to complain that the “Internet is down.” The system may then use this crowdsourced information to generate the enterprise network status results. As used herein, the term “crowdsourced” might refer to, for example, information that was obtained using the services of a relatively large number of people, either paid or unpaid, via a communication network.

At S250, the system may arrange to output an indication of the enterprise network status results through a communication port and interactive user interface displays, including the enterprise network status results, via a distributed communication network. The interactive user interface displays might comprise insight dashboard displays that include, for example, map data, employee location data, network status data, power outage data, network drop counts, graphical indications of drop groupings, heat map data, filter conditions, offshore data, etc.

In some embodiments, the network status algorithm comprises a ML or Artificial Intelligence (“AI”) algorithm trained with historical network status information. For example, the enterprise network status results might be associated with a risk assessment prediction for the enterprise (e.g., how likely is it that the enterprise will see ten percent of all employees unable to access information during the next twelve months?). The risk assessment prediction might be performed, for example, by an insurance provider during an underwriting process. In some embodiments, the underwriting process is associated with a Business Interruption (“BI”) insurance policy for the enterprise. Moreover, results of a risk analysis (or future network insights) might be used as feedback to improve the ML or AI algorithm such that the system may automatically adapt to changing conditions.

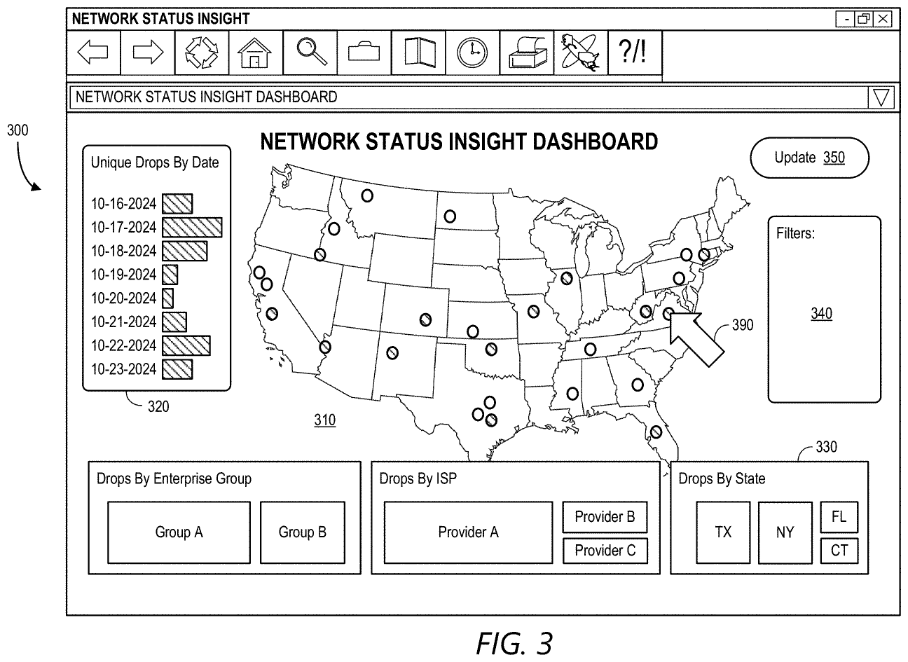

The data analyzed by the system may then be presented on a Graphical User Interface (“GUI”). For example, FIG. 3 is a network status insight display 300 including map information 310 according to some embodiments. The map information may include circles associated with cloud-managed Information Technology (“IT”) provider failures and/or network outage detection platforminformation (and the size of a circle may represent a number of dropped network connections). The display e00 may further include graphs of unique drops by date 320, graphical comparisons of drops by enterprise group (e.g., which department did the dropped workers work in?), drops by ISP, drops by geographic location, etc. The display 300 may further include filter information 340 (to let an administrator focus on certain types of employees or networks). Selection of a portion or element of the display 300 might result in the presentation of additional information about that portion or element (e.g., a popup window presenting the street address associated with a network insight) or let an operator or administrator enter or annotate additional information about a network insight (e.g., based on his or her experience and expertise). Selection of an “Update” icon 350 (e.g., by touchscreen or computer mouse pointer 390) might cause the system or platform to re-analyze the network insight information.

Thus, embodiments may provide remote worker connectivity and power outage real-time analytic solutions. Both analytic solutions might use in-house designed algorithms to combine enterprise data, enterprise machine-generated data, and third-party data to provide a real-time analysis of risks related to reliability and performance of major ISPs (in both the US and abroad) and power utility companies. Also, the solutions may generate historical datasets that can be used by the insurance industry for a ML analysis of reliability and risks related to ISPs and power utility companies

A remote worker connectivity analytic solution might combine Virtual Private Network (“VPN”) machine generated data, enterprise data, and third-party data (outage detectors, map services, etc.) to provide a real time analytics. For example, a first algorithm may find a correlation between a VPN (used by enterprise frontline teams and business essential personnel) connectivity drops and network outage detector (ISP and Internet backbone) failures. For example, an enterprise employee who was on a call with a customer may have experienced a connectivity drop that resulted in loss of potential business. The employee works from her home office in Avon, CT and uses ISP “Provider A.” The connectivity was dropped at 10:15 AM on Nov. 15, 2024. At the same time, several non-enterprise Provider A customers who also live in Avon, Conn. reported problems between 10 AM and 11 AM on the same date. The algorithm may call multiple Restful APIs from multiple third-party vendors and combine data with corporate databases to find this correlation in real-time and mark that incident as potentially ISP/backbone failure related.

As another example, a second algorithm may provide an ability to analyze time series (change connectivity status hour-by-hour for the last 24 hours) that can provide users with additional insights, for example connectivity was OK for all Provider A users located in Hartford, Conn., but starting at 9:30 AM a significant number of users experienced service interruption which may point to a cut fiber cable, or backbone problem, or power outage, or local ISP equipment problem.

As still another example, a third algorithm may provide an ability for users to identify a home Internet or router bandwidth and capacity problem. For example, a claim handler who works from his home office in Florida might share Internet bandwidth with his wife (who also works from home) and their teenage children (who play online games). The algorithm might identify such cases by displaying a larger bubble on a dashboard for users who have larger number of VPN connectivity drops per hour over an extended period of time.

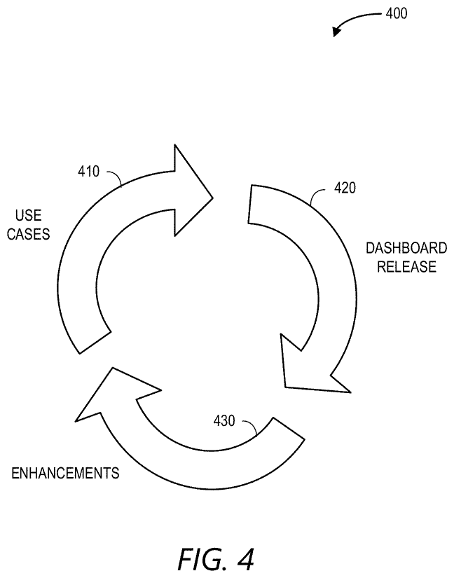

Note that dashboard displays and network insight algorithms may be developed in a number of different ways. For example, FIG. 4 is a dashboard maturity process 400 in accordance with some embodiments. Initially, use cases 410 may be developed. For example, the use cases 410 might be associated with a contact center, client support, business recovery operations, etc. Based on the use cases, dashboard releases 420 may be generated (e.g., for ISP and power utility embodiments). As the dashboard releases are used, specific enhancements 430 may be developed (e.g., a power outage view, automate feeds, user feedback, etc.). The enhancements 430 might lead to additional or modified use cases 410 and the process may continue.

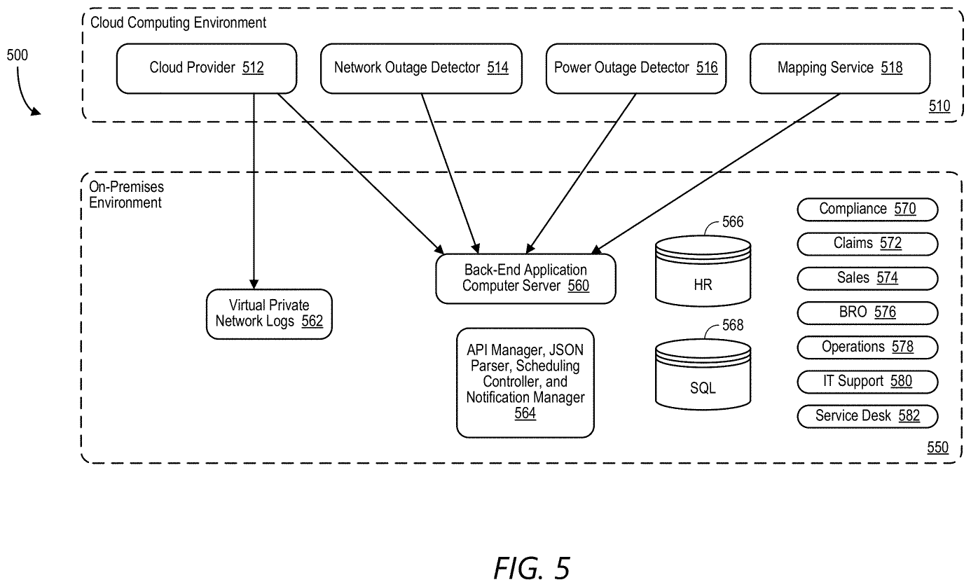

FIG. 5 is a remote worker connectivity dashboard architecture 500 according to some embodiments. A cloud computing environment 510 might include various components, such as a cloud provider 512 (e.g., AMAZON WEB SERVICES®), a network outage detector 514, a power outage detector 516, and a mapping service 518 (e.g., a MICROSOFT BINGO mapping service). These components may communicate with a back-end application computer server 560 in an on-premises environment 550 to generate scheduled daily summery reports to enterprise leadership. For example, the cloud provider 512 might send 100 daily API calls, the network outage detector 514 might send 2,000 daily API calls, and a mapping service 518 might send 2,500 daily API calls. In addition, the cloud provider 512 may store VPN logs 562 in the on-premises environment 550.

The computer server 560 may interface with an Application Programming Interface (“API”) manager, a JavaScript Object Notation (“JSON”) parser, a scheduling controller, and a notification manager 564, HR and other corporate data 566, and a Software Query Language (“SQL”) database 568. The architecture 500 may support various on-premises environment 550 components, such as those associated with compliance 570, insurance claims 572, sales 574, business recovery operation 576, operations 578, IT support 580, a service desk 582, etc.

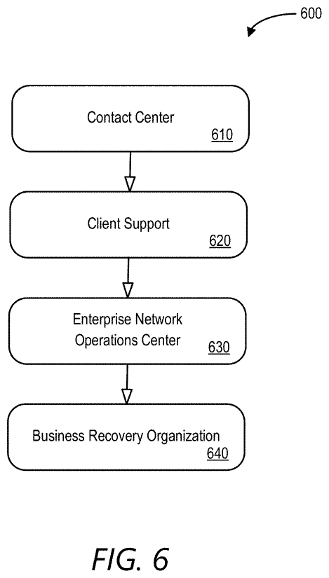

FIG. 6 illustrates use case examples and roadmap items 600 in accordance with some embodiments. A contact center 610 component may be associated with reach-outs and potentially redirect calls due to ISP connectivity, router, and setup issues (real-time and trending). A client support 620 component may be associated with proactive engagement to troubleshoot router setup, internal issues, or persistent ISP challenges. An enterprise network operations center 630 component may be associated with alerts for city and regional ISP outages and impacts to enterprise offices. A business recover organization or operation 640 component may assess and model impacts of power outages to business operations for the enterprise.

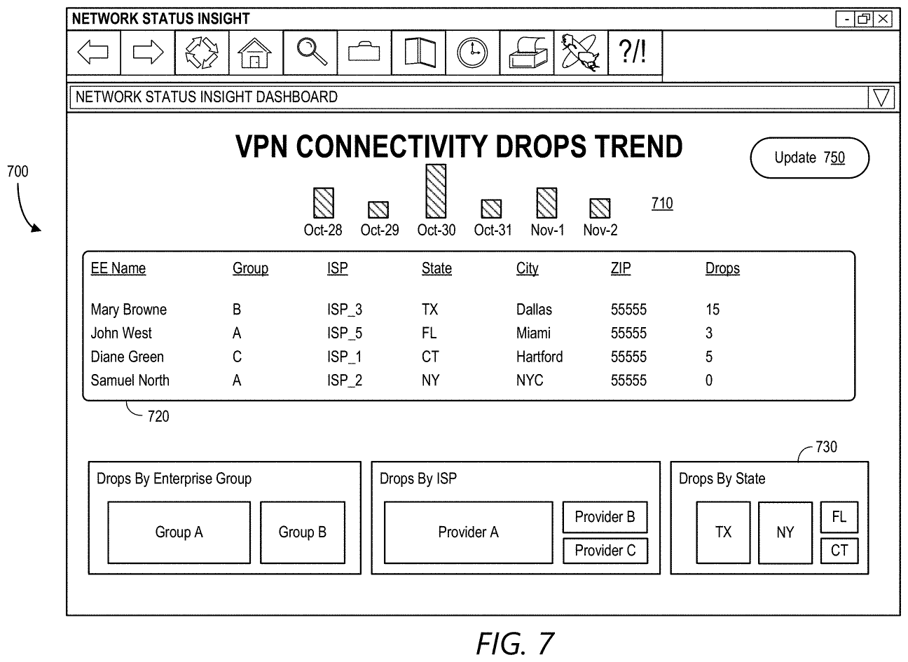

Note that embodiments may utilize any number of various network insight dashboard displays. For example, FIG. 7 is a multi-day connectivity drop trend display 700 according to some embodiments. The display might show, for example, a multi-day VPN connectivity drop trend 710 along with detailed employee data 720, graphical drop comparisons 730, and an “Update” icon 750 to refresh the display 700.

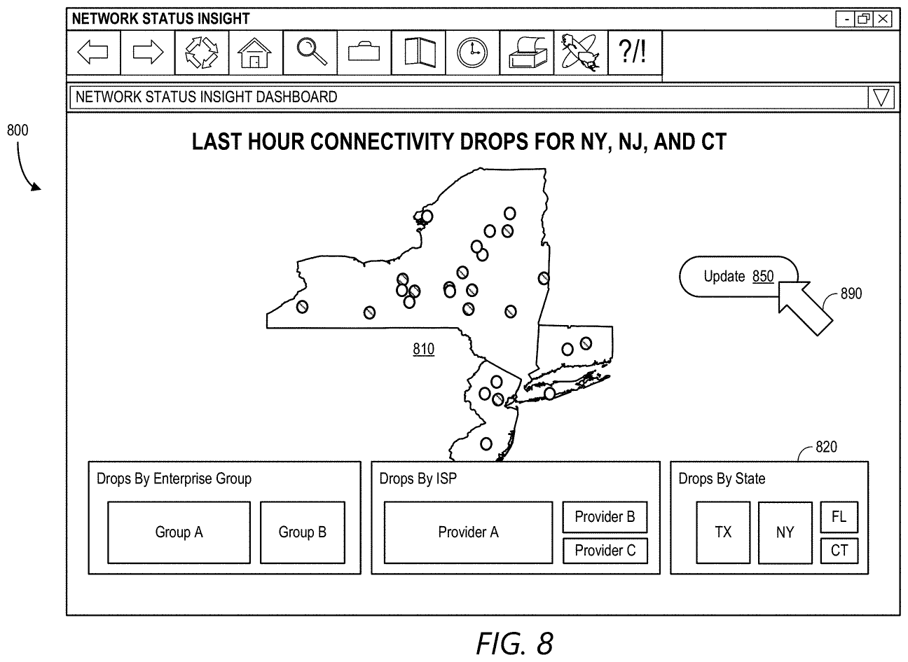

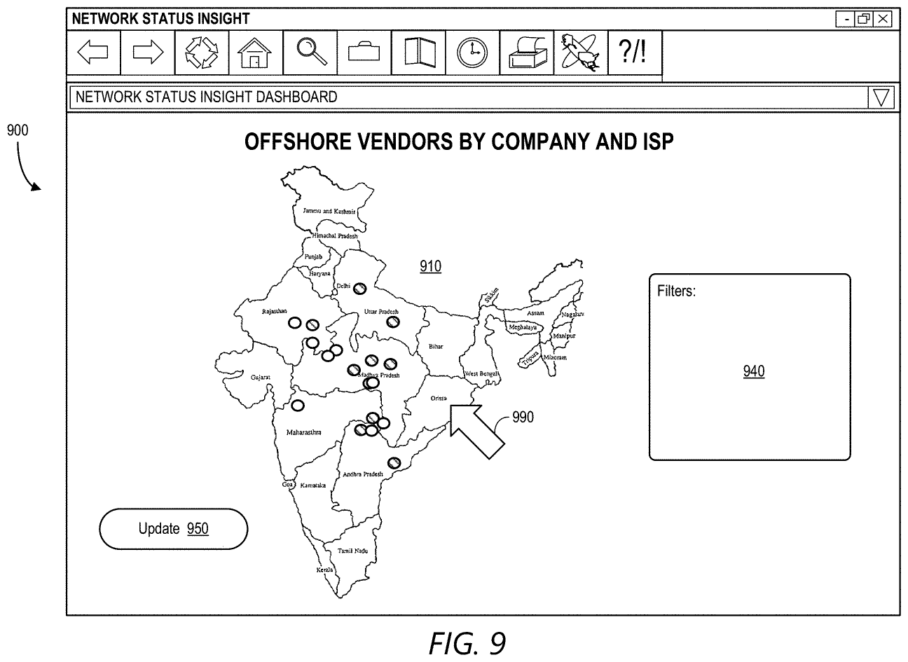

FIG. 8 shows a display 800 with other types of VPN connectivity drops in accordance with some embodiments. The display 800 includes map information 810 for other types of VPN connectivity drops (e.g., for the last hour connectivity results for all claim employees who live in the states of NY, CT, and NJ) along with graphical drop comparisons 830 and an “Update” icon 850 (selectable via touchscreen or computer mouse pointer 890) to refresh the display 800. Note that the graphical drop comparisons 830 might represent granularities associated with countries, states, counties, ZIP codes, etc. and interrupts might be broken into various organizational departments, offices, job descriptions, etc. FIG. 9 is an offshore vendor display 900 according to some embodiments. This display 900 might include map information 910 for enterprise offshore vendors by company and ISP along with filter information 940. An “Update” icon 950 (selectable via touchscreen or computer mouse pointer 990) may refresh the display 900. According to some embodiments, historical datasets may be used for ML and risk evaluation.

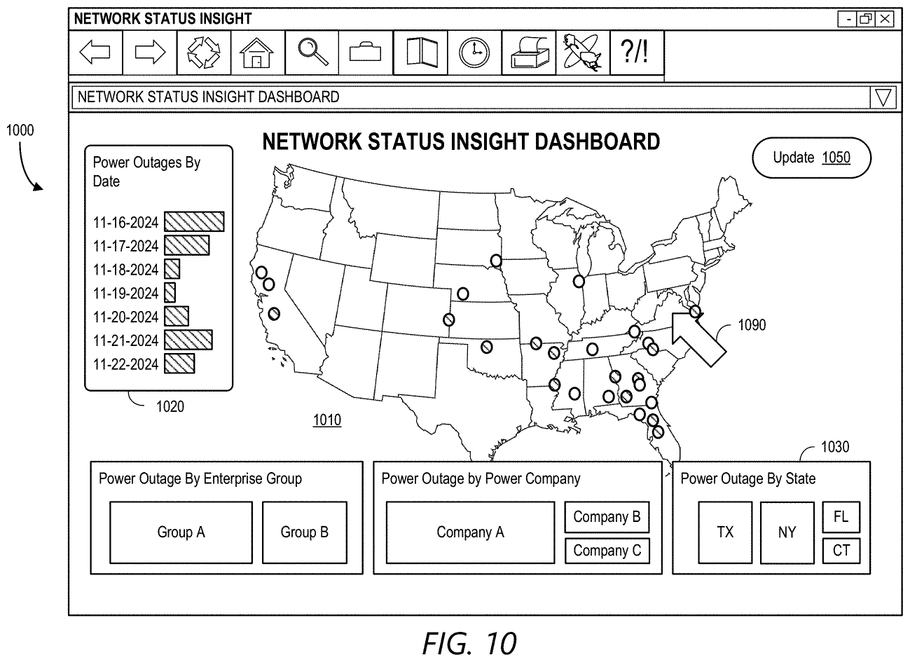

Other embodiments may provide power outage analytic solutions and/or data mining for real time analysis. For example, a power outage analytic solution may use enterprise HR data, Configuration Management DataBase (“CMDB”) information, IT data, and third-party data to provide a real time analytics. A power outage solution might, for example, provide a real time view of employees impacted by power outages classified by company hierarchy, job, and/or business essential function classifications. For example, FIG. 10 is a power outage analytic solution display 1000 in accordance with some embodiments. The display includes map information 1010, power outages by date 1020, graphical power outage comparisons 1030, and an “Update” icon 1050 (selectable via touchscreen or computer mouse pointer 1090) to refresh the display 1000.

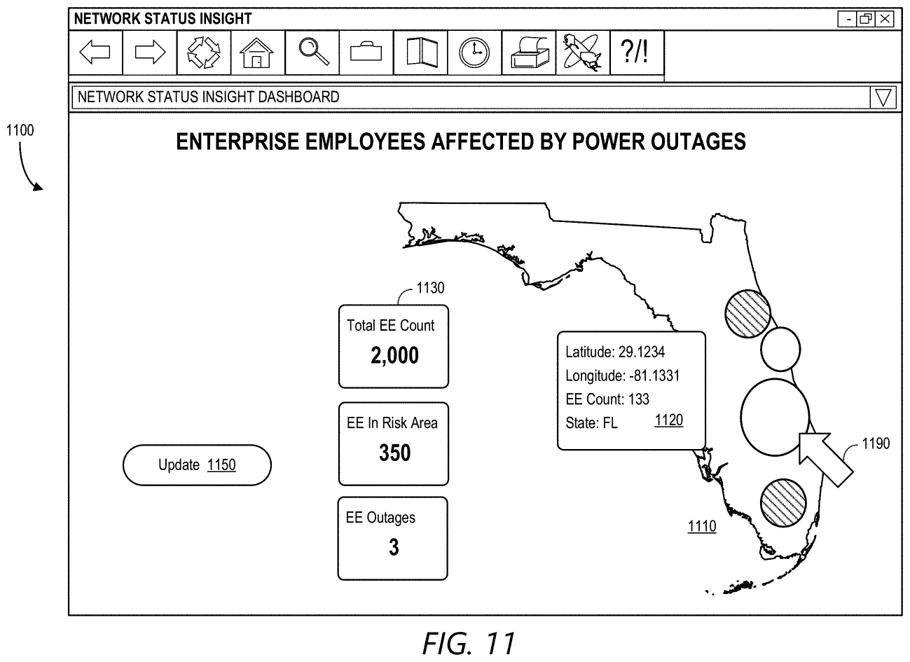

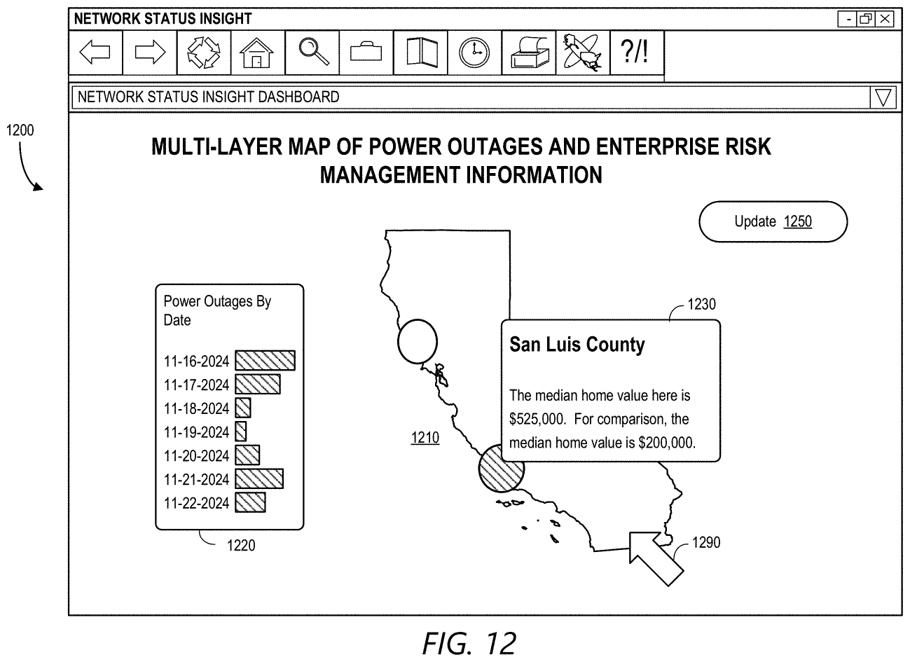

FIG. 11 is an affected employee power outage display 1100 according to some embodiments. Again, the display 1100 includes map information 1110, detailed geographic area information 1120, and employee specific data 1130. The display 1100 also includes an “Update” icon 1150 (selectable via touchscreen or computer mouse pointer 1190) to refresh the display 1100. Similarly, FIG. 12 is a multi-lay map of power outages display 1200 in accordance with some embodiments. This multi-layer map might show power outages affecting enterprise employees overlaying with enterprise or mapping service data and/or maps. Note that historical datasets might be used for ML and risk evaluation. In addition, FIG. 12 shows map information 1210, power outages by date 1220, and detailed map information 1230 along with an “Update” icon 1250 (selectable via touchscreen or computer mouse pointer 1290) to refresh the display 1200.

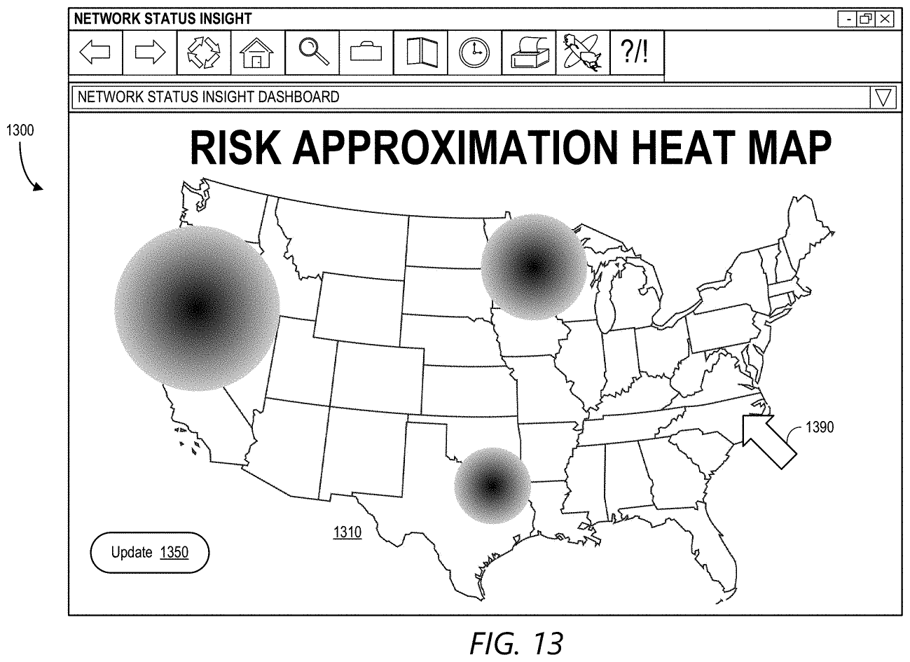

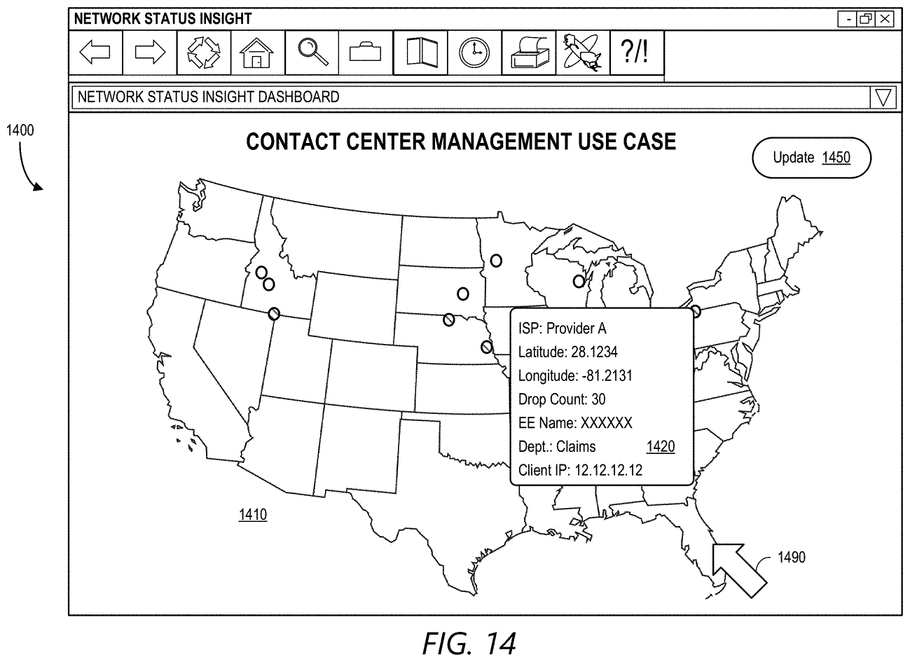

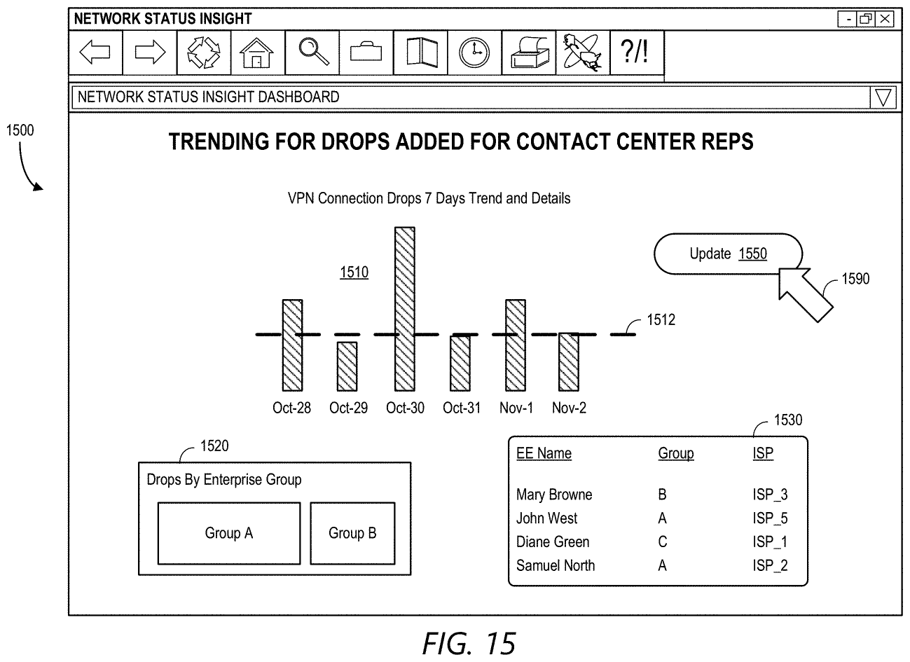

There are other ways to display the information described herein. For example, FIG. 13 is a heat map display 1300 according to some embodiments. The display 1300 includes map information 1310 with a heat map overlay along with an “Update” icon 1350 (selectable via touchscreen or computer mouse pointer 1390) to refresh the display 1300. Similarly, FIG. 14 is a contact center management use case display 1400 in accordance with some embodiments. The display 1400 includes map information 1410 with a heat map overlay, a “drill-down” popup window 1420, and an “Update” icon 1450 (selectable via touchscreen or computer mouse pointer 1390) to refresh the display 1400. FIG. 15 is a drop trend display 1500 according to some embodiments. This display 1500 might include bar graphs 1510 of the number of network drops over a period of time (along with trend line information 1512), drops by enterprise groups 1520, detailed employee data 1530, and an “Update” icon 1550 (selectable via touchscreen or computer mouse pointer 1590) to refresh the display 1500.

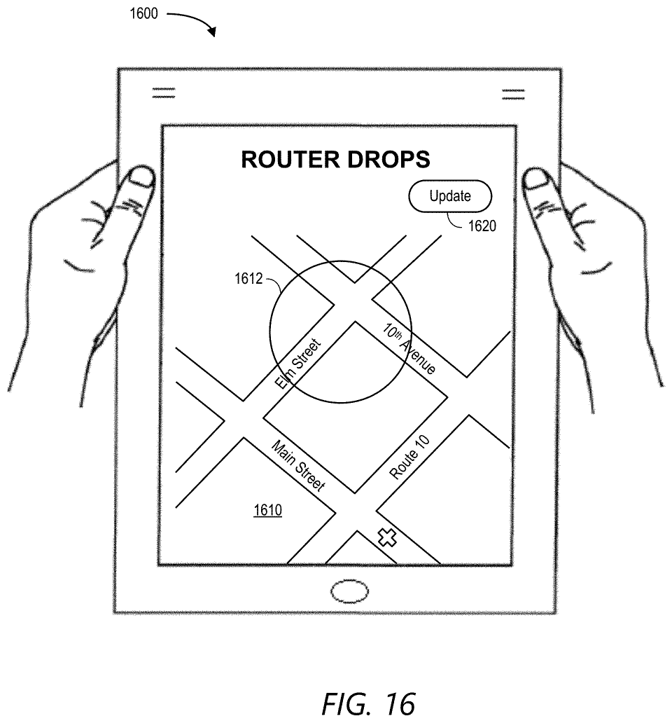

Note that the displays and devices illustrated herein are only provided as examples, and embodiments may be associated with any other types of user interfaces. For example, FIG. 16 illustrates a tablet computer 1600 with a street-level router drop display 1610 according to some embodiments. The street-level router drop display 1610 includes router drop information 1612 that might include user-selectable data that can be modified by a user of the handheld computer 1600 (e.g., via an “Update” icon 1620) to view updated network insight information associated with an enterprise (e.g., including, in some embodiments, network or power outage information).

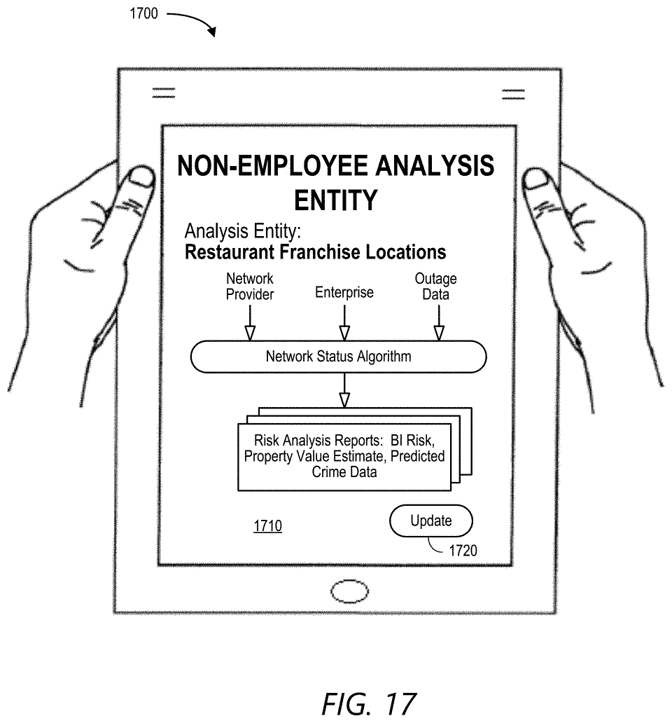

Many of the embodiments described herein are associated with remote employees of an enterprise. Note, however, that embodiments may be associated with other types of analysis entities associated with an enterprise. For example, FIG. 17 illustrates a tablet computer 1700 with a non-employee analysis entity display 1710 according to some embodiments. Here, the entities being analyzed are physical restaurant franchise locations. The network provider, enterprise, and outage data are fed into a network status algorithm that generates risk analysis reports for an enterprise. The risk analysis reports might include, for example, business insurance risk, property value estimates, predicted crime data, etc. The display 1710 may include an “Update” icon 1620) to view updated network insight information associated with the enterprise.

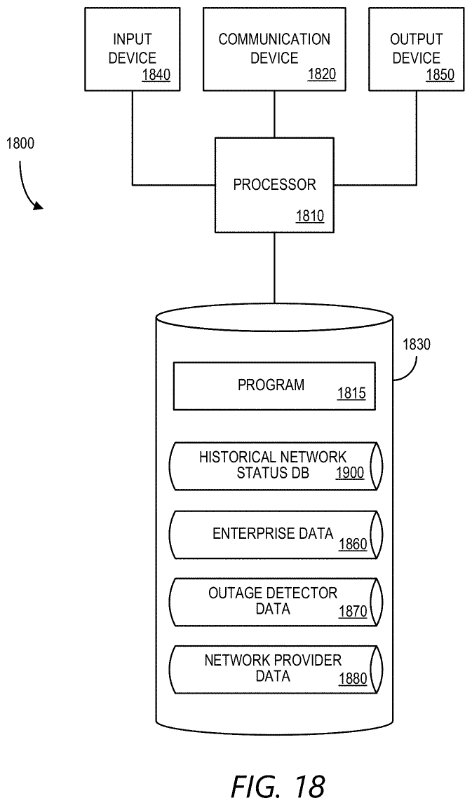

The embodiments described herein may be implemented using any number of different hardware configurations. For example, FIG. 18 illustrates an apparatus 1800 that may be, for example, associated with the system 100 described with respect to FIG. 1. The apparatus 1800 comprises a processor 1810, such as one or more commercially available Central Processing Units (“CPUs”) in the form of one-chip microprocessors, coupled to a communication device 1820 configured to communicate via a communication network (not shown in FIG. 18). The communication device 1820 may be used to communicate, for example, with one or more remote third-party network insight information suppliers, administrator computers, and or communication devices (e.g., PCs and smartphones). Note that communications exchanged via the communication device 1820 may utilize security features, such as those between a public internet user and an internal network of an insurance company and/or an enterprise. The security features might be associated with, for example, web servers, firewalls, and/or PCI infrastructure. The apparatus 1800 further includes an input device 1840 (e.g., a mouse and/or keyboard to enter information about network insights, maps, employees, third-parties, etc.) and an output device 1850 (e.g., to output reports regarding network insight risk current conditions, recommended changes, etc.).

The processor 1810 also communicates with a storage device 1830. The storage device 1830 may comprise any appropriate information storage device, including combinations of magnetic storage devices (e.g., a hard disk drive), optical storage devices, mobile telephones, and/or semiconductor memory devices. The storage device 1830 stores a program 1815 and/or a network insight risk evaluation tool or application for controlling the processor 1810. The processor 1810 performs instructions of the program 1815, and thereby operates in accordance with any of the embodiments described herein. For example, the processor 1810 may apply a network status algorithm to correlate received information to generate enterprise network status results (e.g., for display on an insight dashboard and/or a risk assessment prediction for the enterprise).

The program 1815 may be stored in a compressed, uncompiled and/or encrypted format. The program 1815 may furthermore include other program elements, such as an operating system, a database management system, and/or device drivers used by the processor 1810 to interface with peripheral devices.

As used herein, information may be “received” by or “transmitted” to, for example: (i) the back-end application computer server 1800 from another device; or (ii) a software application or module within the back-end application computer server 1800 from another software application, module, or any other source.

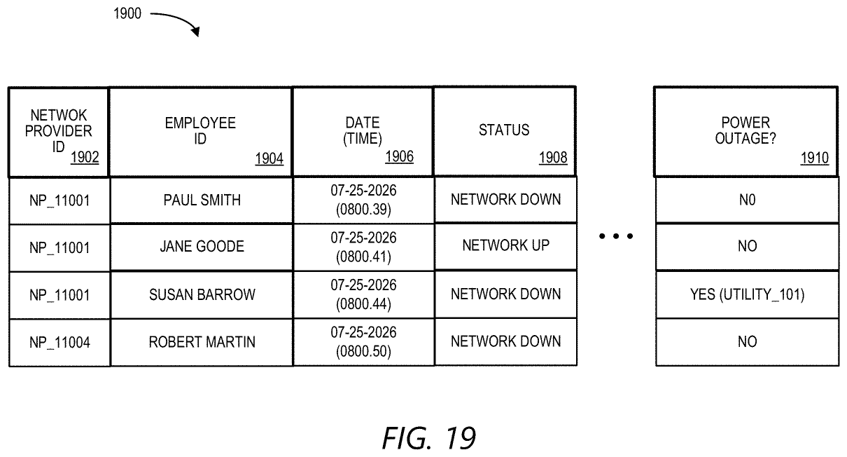

In some embodiments (such as shown in FIG. 18), the storage device 1830 further stores a historical network status database 1900, enterprise data 1860 (e.g., associated with HR information), outage detector data 1870 (e.g., storing recording of past network and power outages, etc.), and network provider data 1880. An example of a database that might be used in connection with the apparatus 1800 will now be described in detail with respect to FIG. 19. Note that the database described herein is only an example, and additional and/or different information may be stored therein. Moreover, various databases might be split or combined in accordance with any of the embodiments described herein. For example, the historical network status database 1900 might be combined and/or linked to each other within the program 1815.

Referring to FIG. 19, a table is shown that represents the historical network status database 1900 that may be stored at the apparatus 1900 according to some embodiments. The table may include, for example, entries associated with networks that have been used by employees working remotely for enterprise. The table may also define fields 1902, 1904, 1906, 1908, 1910 for each of the entries. The fields 1902, 1904, 1906, 1908, 1910 may, according to some embodiments, specify: a network provider identifier 1902, an employee identifier 1904, a date and time 1906, a status 1908, and a power outage indication 1910. The historical network status database 1900 may be created and updated, for example, based on information electronically received from various computer systems, including those associated with enterprise systems, outage detectors, network providers, and third-parties.

The network provider identifier 1902 may be, for example, a unique alphanumeric code identifying a service that is provide network connectivity for workers of an enterprise. The employee identifier 1904 might identify the worker, including, for example, a worker location. The date and time 1906 might indicate when the status 1908 was updated (e.g., if the status 1908 is network down or network up). The power outage indication 1910 might, according to some embodiments, overlay public utility data over the network status data.

Thus, embodiments may provide an automated and efficient way of mining network insight data (e.g., associated with various insurers, network providers, third-parties, etc.) to identify network insight risk factors and for developing network insight risk mitigation strategies in a way that provides fast and accurate results. Embodiments may also provide an ability to access and interpret data in a holistic, tactical fashion. According to some embodiments, the system may be agnostic regarding particular web browsers, sources of information, etc. For example, information from multiple sources (e.g., an internal insurance policy database and an external data store) might be blended and combined (with respect to reading and/or writing operations) so as to appear as a single “pool” of information to a user at a remote device. Moreover, embodiments may be implemented with a modular, flexible approach such that deployment of a new system for an enterprise might be possible relatively quickly.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein. Similarly, although certain attributes were described in connection some embodiments herein, other types of attributes might be used instead.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A network status insight system implemented via a back-end application computer server, comprising:
(a) a network provider data store that contains electronic records, each electronic record representing a network provider of an enterprise, and including, for each network provider, an electronic record identifier and a set of network attribute values;
(b) an enterprise data store that contains electronic records, each electronic record representing a remote analysis entity of the enterprise, and including, for each analysis entity, an electronic record identifier and a set of analysis entity attribute values;
(c) the back-end application computer server, coupled to the network provider data store, including:
a computer processor, and
a computer memory, coupled to the computer processor, storing instructions that, when executed by the computer processor cause the back-end application computer server to:
receive, from the enterprise data store, information about analysis entities of the enterprise,
receive, from the network provider data store, information about networks used by the enterprise,
receive, from a third-party outage detector platform, information about outages associated with the enterprise,
apply a network status algorithm to correlate the information about analysis entities of the enterprise, the information about networks used by the enterprise, and the information about outages associated with the enterprise to generate enterprise network status results, and
arrange to output an indication of the enterprise network status results; and
(d) a communication port coupled to the back-end application computer server to facilitate a transmission of data with remote user devices to support interactive user interface displays, including the enterprise network status results, via a distributed communication network.

2. The system of claim 1, wherein the network attribute values include at least one of: (i) a network identifier, (ii) a network status, (iii) a network address, (iv) location information, and (v) a status date and time.

3. The system of claim 1, wherein the analysis entities comprise employees and the analysis entity attribute values include at least one of: (i) an employee identifier, (ii) an employee name, (iii) an employee status, (iv) a network service provider, (v) a communication address, and (vi) location information.

4. The system of claim 1, wherein the third-party outage detector platform comprises a network outage detector platform.

5. The system of claim 1, wherein the third-party outage detector platform comprises a power outage detector platform.

6. The system of claim 1, wherein the back-end application computer server receives information from both a network outage detector platform and a power outage detector platform.

7. The system of claim 1, wherein the back-end application computer server receives crowdsourced information from at least one crowdsourcing platform and uses the crowdsourced information to generate the enterprise network status results.

8. The system of claim 1, wherein the interactive user interface displays comprise insight dashboard displays including at least one of: (i) map data, (ii) employee location data, (iii) network status data, (iv) power outage data, (v) drop counts, (vi) graphical indications of drop groupings, (vii) heat map data, (viii) filter conditions, and (ix) offshore data.

9. The system of claim 1, wherein the network status algorithm comprises a Machine Learning (“ML”) or Artificial Intelligence (“AI”) algorithm trained with historical network status information.

10. The system of claim 9, wherein the analysis entities are employees and the enterprise network status results are associated with a risk assessment prediction for the enterprise.

11. The system of claim 10, wherein the risk assessment prediction is performed by an insurance provider during an underwriting process.

12. The system of claim 11, wherein the underwriting process is associated with a business interruption insurance policy for the enterprise.

13. A computerized network status insight method implemented via a back-end application computer server, comprising:
receiving, at a computer processor of a back-end application computer server from an enterprise data store, information about employees of the enterprise, wherein the enterprise data store contains electronic records, each electronic record representing a remote employee of the enterprise and including, for each employee, an electronic record identifier and a set of employee attribute values;
receiving, from a network provider data store, information about networks used by the enterprise, wherein the network provider data store contains electronic records, each electronic record representing a network provider of an enterprise and including, for each network provider, an electronic record identifier and a set of network attribute values;
receiving, from a third-party outage detector platform, information about outages associated with the enterprise;
applying a network status algorithm to correlate the information about employees of the enterprise, the information about networks used by the enterprise, and the information about outages associated with the enterprise to generate enterprise network status results; and
arranging to output an indication of the enterprise network status results through a communication port and interactive user interface displays, including the enterprise network status results, via a distributed communication network.

14. The method of claim 13, wherein the network attribute values include at least one of: (i) a network identifier, (ii) a network status, (iii) a network address, (iv) location information, and (v) a status date and time.

15. The method of claim 13, wherein the employee attribute values include at least one of: (i) an employee identifier, (ii) an employee name, (iii) an employee status, (iv) a network service provider, (v) a communication address, and (vi) location information.

16. The method of claim 13, wherein the third-party outage detector platform comprises a network outage detector platform.

17. The method of claim 13, wherein the third-party outage detector platform comprises a power outage detector platform.

18. The method of claim 13, wherein the back-end application computer server receives information from both a network outage detector platform and a power outage detector platform.

19. A non-transitory, computer-readable medium storing instructions, that, when executed by a processor, cause the processor to perform a network status insight method implemented via a back-end application computer server, the method comprising:
receiving, at a computer processor of a back-end application computer server from an enterprise data store, information about employees of the enterprise, wherein the enterprise data store contains electronic records, each electronic record representing a remote employee of the enterprise and including, for each employee, an electronic record identifier and a set of employee attribute values;
receiving, from a network provider data store, information about networks used by the enterprise, wherein the network provider data store contains electronic records, each electronic record representing a network provider of an enterprise and including, for each network provider, an electronic record identifier and a set of network attribute values;
receiving, from a third-party outage detector platform, information about outages associated with the enterprise;
applying a network status algorithm to correlate the information about employees of the enterprise, the information about networks used by the enterprise, and the information about outages associated with the enterprise to generate enterprise network status results; and
arranging to output an indication of the enterprise network status results through a communication port and interactive user interface displays, including the enterprise network status results, via a distributed communication network.

20. The medium of claim 1, wherein the network status algorithm comprises a Machine Learning (“ML”) or Artificial Intelligence (“AI”) algorithm trained with historical network status information.

21. The medium of claim 9, wherein the enterprise network status results are associated with a risk assessment prediction for the enterprise.

22. The medium of claim 10, wherein the risk assessment prediction is performed by an insurance provider during an underwriting process.

23. The medium of claim 11, wherein the underwriting process is associated with a business interruption insurance policy for the enterprise.
